(19) United States
(12) Patent Application Publication
(10) Pub. No.: US 2026/0320742 A1
(43) Pub. Date: Oct. 15, 2026

(54) METHOD AND APPARATUS FOR IMAGE PROCESSING AND MODEL TRAINING

(71) Applicant: Smarter Silicon (Shanghai) Technologies Co., Ltd., Shanghai (CN)

(72) Inventors: Chih Ming FU, Shanghai (CN); Wenjie YANG, Shanghai (CN); Yilan WANG, Shanghai (CN)

(21) Appl. No.: 19/467,435

(22) Filed: Feb. 2, 2026

(30) Foreign Application Priority Data
Mar. 17, 2025 (CN) 202510314154.6

(51) Int. Cl. G06T 3/4053; G06T 5/73

(52) U.S. Cl. CPC G06T 3/4053; G06T 5/73; G06T 2207/20081

(57) ABSTRACT

A image processing method including, obtaining a first decoded image and determining a target encoding method corresponding to the first image; from a plurality of super-resolution models, determining a target super-resolution model corresponding to the target encoding method, the plurality of super-resolution models corresponding to different encoding type groups, the target encoding method matching the encoding type group corresponding to the target super-resolution model, encoding methods within the same encoding type group sharing at least one common encoding characteristic; and using the target super-resolution model to process the first image to obtain a second image.

### CROSS-REFERENCES TO RELATED APPLICATION

This application claims priority to Chinese Patent Application No. 202510314154.6 filed on Mar. 17, 2025, the entire content of which is incorporated herein by reference.

### FIELD OF TECHNOLOGY

The present disclosure relates to the field of image processing technology and, more specifically, to a method and apparatus for image processing and model training.

### BACKGROUND

Super-resolution reconstruction refers to the technology that enables the recovery of a high-resolution image from a low-resolution image. However, currently, the image quality of super-resolution images obtained by reconstructing low-resolution images using super-resolution reconstruction technology is relatively poor.

### SUMMARY

One aspect of this disclosure provides an image processing method. The image processing method includes obtaining a first decoded image and determining a target encoding method corresponding to the first image; from a plurality of super-resolution models, determining a target super-resolution model corresponding to the target encoding method; and using the target super-resolution model to process the first image to obtain a second image. The plurality of super-resolution models correspond to different encoding type groups, and the target encoding method matches the encoding type group corresponding to the target super-resolution model. The encoding methods within the same encoding type group share at least one common encoding characteristic.

Another aspect of this disclosure provides a model training method. The model training method includes determining at least two encoding type groups, each corresponding to a to-be-trained super-resolution model, encoding methods within the same encoding type group sharing at least one common encoding characteristic; for each encoding method corresponding to each encoding type group, obtaining a first sample image encoded using the encoding method corresponding to the encoding type group, and a second sample image corresponding to the first sample image; and for each encoding type group, using the first sample image corresponding to the encoding type group as training data and the second sample image corresponding to the first sample image as a training target to train the super-resolution model corresponding to the encoding type group to obtain a trained super-resolution model corresponding to the encoding type group. The quality of the second sample image is higher than quality of the first sample image.

Another aspect of this disclosure provides an image processing apparatus. The image processing apparatus includes a type determination unit, a model determination unit and an image processing unit. The type determination unit is configured to obtain a decoded first image and determine a target encoding method corresponding to the first image. The model determination unit is configured to determine a target super-resolution model corresponding to the target encoding method from a plurality of super-resolution models. The plurality of super-resolution models correspond to different encoding type groups. The target encoding method matches the encoding type group corresponding to the target super-resolution model. The encoding methods within the same encoding type group share at least one common encoding characteristic. The image processing unit is configured to process the first image using the target super-resolution model to generate a second image.

Another aspect of this disclosure provides a model training apparatus. The model training apparatus includes a model determination unit, a sample acquisition unit and a model training unit. The model determination unit is configured to determine at least two encoding type groups, each corresponding to a to-be-trained super-resolution model. The encoding methods within the same encoding type group share at least one common encoding characteristic. The sample acquisition unit is configured to, for each encoding method corresponding to each encoding type group, obtain a first sample image encoded using the encoding method corresponding to the encoding type group, and a second sample image corresponding to the first sample image. The model training unit is configured to, for each encoding type group, use the first sample image corresponding to the encoding type group as training data and the second sample image corresponding to the first sample image as a training target to train the super-resolution model corresponding to the encoding type group to obtain a trained super-resolution model corresponding to the encoding type group. The quality of the second sample image is higher than quality of the first sample image.

### BRIEF DESCRIPTION OF THE DRAWINGS

The above-described and other features, advantages and aspects of the embodiments of the present disclosure will become more evident in combination with the accompanying drawings and with reference to the following specific embodiments. Throughout the drawings, the same or similar reference numerals represent the same or similar elements. It should be understood that the drawings are schematic and that the components and elements are not necessarily drawn to scale.

FIG. 1 is a flowchart of an image processing method according to some embodiments of the present disclosure.

FIG. 2 is a flowchart of a model training processing method according to some embodiments of the present disclosure.

FIG. 3 is a flowchart of the model training method according to some embodiments of the present disclosure.

FIG. 4 is an example implementation framework for training a super-resolution model corresponding to a single encoding according to some embodiments of the present disclosure.

FIG. 5 is a flowchart of the image processing method according to some embodiments of the present disclosure.

FIG. 6 is a schematic structural diagram of an image processing apparatus according to some embodiments of the present disclosure.

FIG. 7 is a schematic structural diagram of a model training apparatus according to some embodiments of the present disclosure.

FIG. 8 is a schematic structural diagram of an electronic device according to some embodiments of the present disclosure.

### DETAILED DESCRIPTION

The following describes the embodiments of the present disclosure with reference to the accompanying drawings. The terms used in the embodiments of the present disclosure are only used to explain the specific embodiments of the present disclosure, and are not intended to limit the present disclosure. One of ordinary skilled in the art may learn that, with technology development and emergence of a new scenario, the technical solutions provided in embodiments of the present disclosure are also applicable to a similar technical problem.

In this specification, claims, and accompanying drawings of the present disclosure, the terms “first”, “second”, and the like are intended to distinguish between similar objects but do not necessarily indicate a specific order or sequence. It should be understood that the terms used in such a way are interchangeable in proper circumstances, and this is merely a discrimination manner for describing objects having a same attribute in embodiments of the present disclosure. In addition, the terms “include”, “contain” and any other variants mean to cover the non-exclusive inclusion such that a process, method, system, product, or device that includes a series of units is not necessarily limited to those units, but may include other units not expressly listed or inherent to such a process, method, system, product, or device.

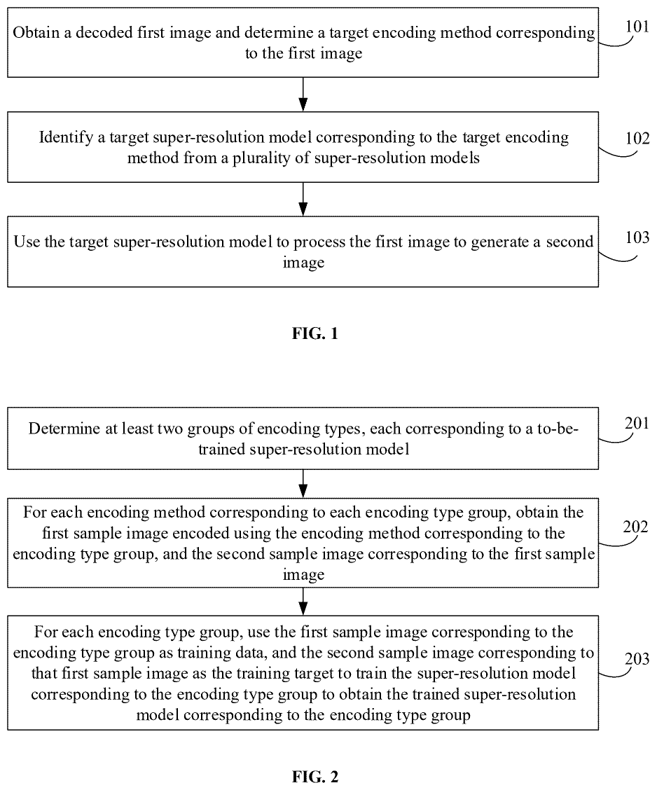

FIG. 1 is a flowchart of an image processing method according to some embodiments of the present disclosure. The image processing method can be applied to electronic device such as laptops, desktop computers, tablet computers, or even a device node in a cloud or a distributed cluster. The type of the device is not limited in the present disclosure. The method will be described in detail below.
101, obtaining a decoded first image and determining a target encoding method corresponding to the first image.

In some embodiments, the first image may be the image that needs to be processed using a super-resolution model for image reconstruction. Since the first image is an image decoded from an encoded and compressed image, it is affected by the encoder. For example, the encoding process performed by the encoder can introduce noise during image compression, resulting in relatively lower image quality in the decoded image. In this way, the first image can have a relatively low image resolution and contain a lot of noise.

In some embodiments, the target encoding method may be the same encoding method used when encoding the first image. The encoding method used to encode the first image can differ depending on the type of encoder used for that image. Therefore, the target encoding method can be the same as the encoding method used by the encoder that encodes the first image.

In the present disclosure, various encoding methods can be used, such as, but not limited to, Joint Photographic Experts Group (JPEG) encoding, High Efficiency Video Coding (HEVC), or H.264 (Advanced Video Coding for Moving Pictures Experts Group-4). In some embodiments, High Efficiency Video Coding is also known as H.265 encoding.

In some embodiments, the target encoding method corresponding to the first image may be determined by analyzing the metadata of the first image. The metadata of the first image may include at least the encoding type of the first image, and may also include other attribute information of the first image. The metadata of the first image is not limited in the present disclosure. For example, since the first image is obtained by decoding the encoded image, the metadata of the encoded image can be obtained. Based on the metadata of the encoded image, the target encoding method of the encoded image is determined, thereby obtaining the target encoding method corresponding to the first image. In some embodiments, the metadata of the encoded image is actually the metadata of the first image.

The target encoding method may also be determined by analyzing the file extension of the first image; or, by using a specific encoding detection tool to detect the target encoding method corresponding to the first image; or by analyzing image encoding-related features such as the compression noise pattern or frequency domain characteristics corresponding to the first image to determine the target encoding method corresponding to the first image. The method of determining the target encoding method is not limited in the present disclosure.

It should be noted that in the present disclosure, the first image can be an independent single-frame image or an image frame from a video, which is not limited in the present disclosure.
102, identifying a target super-resolution model corresponding to the target encoding method from a plurality of super-resolution models.

In some embodiments, a plurality of super-resolution models can correspond to different groups of encoding types, and the target encoding method can correspond to the group of encoding types corresponding to the target super-resolution model. For ease of distinction, the super-resolution model corresponding to the target encoding method can be referred to as the target super-resolution model, and the target super-resolution model can be one of the plurality of super-resolution models.

In the present disclosure, the encoding methods corresponding to the same encoding type group may have at least one identical encoding characteristic. For example, encoding methods that correspond to the same encoding type group may include at least two encoding methods, and these at least two encoding methods may share one or more common encoding characteristics. Based on this, in the present disclosure, different encoding methods that share at least one common encoding characteristic can correspond to the same encoding type group, and the various encoding methods corresponding to the same encoding type group can share the same super-resolution model. This eliminates the need to build a separate super-resolution model for each encoding method, naturally reducing the number of super-resolution models that need to be built and stored.

In some embodiments, possible groups of encoding types can be predefined. In this way, the encoding methods included in each encoding type group can be predetermined. Of course, the encoding methods within the same encoding type group can share at least one common characteristic. In this case, after determining the target encoding method corresponding to the first image, the target encoding type group including that target encoding method can be determined, and the target super-resolution model corresponding to the target encoding type group can be identified.

In other embodiments, the present disclosure may only identify at least one encoding characteristic corresponding to each group of encoding types, but the encoding methods included in the groups of encoding types are not pre-classified. In this case, after determining the target encoding method corresponding to the first image, based on the encoding features of the target encoding method, the target encoding type group corresponding to the target encoding method can be determined, and the target super-resolution model corresponding to the target encoding type group can be identified.

The encoding methods can have multiple dimensions of encoding characteristics. For example, the encoding characteristics of an encoding method can include, but are not limited to, the underlying encoding algorithm principles, encoding complexity, and applicable scenarios.

The following takes the encoding characteristics based on the principles of coding algorithms as an example to determine different groups of encoding types.

Different types of encoding groups may correspond to different encoding algorithm principles. For example, the encoding algorithm principles corresponding to different encoding types can include transform-based encoding (also known as transform coding), block-based predictive coding, or entropy-based encoding, etc.

For example, for the group of encoding types based on transform coding, the corresponding encoding method can be transform-based encoding. Therefore, the encoding methods that correspond this group of encoding types may include, but are not limited to, JPEG encoding, AV1 (AOMedia Video 1) encoding, and intra-frame encoding (VCC Intra) in Versatile Video Coding (VCC).

For the group of encoding types based on block-based prediction and characteristic matching, the corresponding encoding method can utilize block-based prediction. Therefore, the encoding methods that correspond to this group of encoding types may include, but are not limited to: H.264 encoding, HEVC encoding, and inter-frame encoding in VCC (VCC Inter).

Similarly, for the groups of encoding types corresponding to various entropy-based encoding methods, the encoding methods can include, but are not limited to: Huffman coding and Shannon coding, etc. In the present disclosure, the target super-resolution model is suitable for performing super-resolution reconstruction on images encoded using various encoding methods that match the set of encoding types corresponding to that target super-resolution model. For ease of distinction, the group of encoding types corresponding to the target super-resolution model can be referred to as the target encoding type group. For example, the target super-resolution model can perform targeted noise reduction on images encoded using any encoding method corresponding to the target encoding type group, reducing the type of noise introduced into the image by the encoder of any encoding method corresponding to that target encoding type group.

The target super-resolution model may be a trained model, and many model types can be used as the target super-resolution model. For example, the target super-resolution model can be a convolutional neural network model, a deep recurrent convolutional network, or a generative adversarial network model, etc. The present disclosure does not limit the model type of the target super-resolution model.

The method of training the target super-resolution model is not limited in the present disclosure. In some embodiments, the target super-resolution model may be a trained super-resolution model corresponding to the target encoding type group that uses a first sample image encoded using the encoding method corresponding to the target encoding type group as the training data, and a second sample image corresponding to the first sample image as the training target, where the quality of the second sample image is higher than the quality of the first sample image.

The higher quality of the second sample image compared to the first sample image can be demonstrated in several ways. For example, if the quality of the second sample image is higher than the quality of the first sample image, then the resolution of the second sample image is higher than the resolution of the first sample image, the second sample image has less noise than the first sample image, the edge sharpness and detail richness of the second sample image are higher than those of the first sample image, etc.
103, using the target super-resolution model to process the first image to generate a second image.

In some embodiments, the second image may be a high-quality image generated by the target super-resolution model based on the first image; therefore, the quality of the second image may be higher than the quality of the first image.

For example, if the quality of the second image is higher than that of the first image, this can at least indicate that the resolution of the second image is higher than the resolution of the first image. Of course, the quality of the second image is higher than the quality of the first image can also be indicated as the second image containing less noise than the first image, etc.

It can be understood that, after generating the second image, the second image can also be output, thereby allowing the user to obtain a second image with relatively high image quality. Of course, in practical applications, after generating the second image, the second image can be saved as needed, which will not be described in detail here.

Consistent with the present disclosure, after decoding the first image, the target encoding method corresponding to the first image can be determined. The first image is processed using the target super-resolution model corresponding to the target encoding type group that matches the target encoding method. This allows for the selection of a target super-resolution model suitable for processing the first image encoded using that specific target encoding method, enabling the target super-resolution model to more effectively remove noise or other artifacts introduced during the encoding process of the first image, thereby improving the image quality of the generated second image.

In addition, the encoding methods corresponding to the same encoding type group have at least one common encoding characteristic, making the encoding characteristics of the encoding methods corresponding to the same encoding type group similar. This allows the encoding methods corresponding to the same encoding type group to share the same super-resolution model. This not only increases the range of encoding methods applicable to a single super-resolution model, but also reduces the number of super-resolution models that need to be built and stored.

In some embodiments, in order to efficiently determine the super-resolution model corresponding to the encoding type group that matches the encoding method, and to reduce the time required to determine the super-resolution model corresponding to the encoding method, a mapping list may be constructed. The mapping list can record multiple groups of encoding types, each including at least two encoding methods, as well as the super-resolution model corresponding to each group of encoding types. In the mapping list, different super-resolution models may correspond to different groups of encoding types.

Based on this, in the present disclosure, the target super-resolution model corresponding to the target encoding method can be determined using the mapping list.

For example, the mapping list can record the group identifier for each encoding type group, at least two encoding methods corresponding to each group identifier, and the model identifier of the super-resolution model corresponding to each group identifier. The group identifier may include encoding characteristics common to all encoding methods within the encoding type group, or information such as the group number corresponding to the encoding type group, used to uniquely identify the encoding type group. Similarly, the model identifier for the super-resolution model may be the model name, number, or access address of the super-resolution model.

By using a mapping list to determine the target super-resolution model corresponding to the target encoding method, the time spent on calculating the target encoding type group that matches the encoding features of the target encoding method can be reduced, thus naturally improving the efficiency of determining the target super-resolution model. This can reduce the time required to process the first image awaiting reconstruction, thereby improving the efficiency of super-resolution image reconstruction of the first image.

In the present disclosure, each group of encoding types can correspond to multiple possible model structures for the super-resolution model. For detail, reference can be made to the possible model structures for the target super-resolution model described above, which will not be repeated here.

Each super-resolution model can be pre-trained, and the training process is not limited in the present disclosure. By training various super-resolution models, the same super-resolution model can produce different results when applied to images encoded using different encoding methods corresponding to different encoding types.

In some embodiments, in order to enable the super-resolution model corresponding to each type of encoding group to focus on the noise and other effects introduced by the various encoding methods (or the encoders corresponding to these encoding methods) within that encoding group during image encoding, for any given group of encoding types corresponding to a super-resolution model, the super-resolution model can be a trained super-resolution model that corresponds to the group of encoding types that uses the first sample image encoded with each encoding method in the group of encoding types as training data, and the second sample image corresponding to that first sample image as the training target. As described above, the quality of the second sample image may be higher than the quality of the first sample image.

For any given group of encoding types, each first sample image may correspond to one encoding method within that group of encoding types. In addition, multiple first sample images may be used to train the super-resolution model, and the encoding methods corresponding to these multiple first sample images may include at least two different encoding methods from that group of encoding types.

For ease of understanding, the following describes an implementation method for training super-resolution models corresponding to various encoding type groups. FIG. 2 is a flowchart of a model training processing method according to some embodiments of the present disclosure. The method will be described in detail below.
201, determining at least two groups of encoding types, each corresponding to a to-be-trained super-resolution model.

In some embodiments, the encoding methods that match the same encoding type group may share at least one common encoding characteristic. For example, before training a super-resolution model, at least two matching types may be determined for each group of encoding types.

The model types of the to-be-trained super-resolution models corresponding to different encoding types may be the same or different, and may be selected based on actual needs. For details of the types of the super-resolution models that can be used, reference can be made to the relevant information described above, which will not be repeated here.
202, for each encoding method corresponding to each encoding type group, obtaining the first sample image encoded using the encoding method corresponding to the encoding type group, and the second sample image corresponding to the first sample image.

In some embodiments, the first sample image may be an image obtained by encoding an original image, which meets the image quality requirements, using an encoder corresponding to one of the encoding methods in the encoding type group. The quality of the original image may be higher than the quality of the first sample image.

In some embodiments, each encoding type group may correspond to multiple first sample images, and the multiple first sample images may include at least one first sample image encoded using each encoding method within that encoding type group.

Take the case where all encoding methods in the encoding type group belong to transform-based compression encoding as an example. Assume the group of encoding types includes both JPEG and AV1 encoding methods, a JPEG encoder can be used to compress and encode at least one original image with a resolution exceeding a predetermined threshold, resulting in at least one first sample image corresponding to that JPEG encoding method, and an AV1 encoder can be used to compress and encode at least one original image with a resolution exceeding a predetermined threshold, resulting in at least one first sample image corresponding to that AV1 encoding method. Each first sample image may include the same object content as its corresponding original image, but the first sample image has a lower resolution than the original image.

In some embodiments, the quality of the second sample image may be higher than the quality of the first sample image.

The goal of training the super-resolution model corresponding to the encoding type group is to enable this super-resolution model to generate the second sample image based on the first sample image, therefore, the second sample image can serve as the training target for the super-resolution model corresponding to the encoding type group.
203, for each encoding type group, using the first sample image corresponding to the encoding type group as training data, and the second sample image corresponding to that first sample image as the training target to train the super-resolution model corresponding to the encoding type group to obtain the trained super-resolution model corresponding to the encoding type group.

Using the second sample image corresponding to the first sample image as the training target aims to minimize the difference between the target image generated by the super-resolution model based on the first sample image and the first sample image itself. This ensures that the target image generated by the super-resolution model based on the first sample image is as similar as possible to the second sample image.

Consistent with the present disclosure, for each type of encoding group, the first sample images encoded using each encoding method within that encoding group are used as training data, and the corresponding second sample images with relatively higher quality are used as training targets to train the super-resolution model corresponding to the encoding group. This ensures that the super-resolution model corresponding to each type of encoding group can reconstruct high-quality images from images encoded using any encoding method within the group.

In addition, although each encoding method within a given encoding type group introduces noise when encoding an image, the types of noise introduced by the encoders corresponding to the different encoding methods within the same encoding type group are similar. Therefore, using the same super-resolution model to reconstruct the images encoded by each encoding method within each encoding type group not only allows the super-resolution model to effectively remove the specific type of noise introduced by the encoder corresponding to that encoding type group, which improves the quality of the reconstructed super-resolution image. Images, but also effectively reduces the large number of models and high maintenance costs that would result from training a separate super-resolution model for each encoding method within the encoding type group.

During the training of the super-resolution model for each type of encoding group, the corresponding loss function may need to be used to control the training process. The loss function can be used to quantify the difference between the target image generated by the super-resolution model based on the first sample image and the corresponding second sample image. For example, the value of the loss function can be used to determine whether the super-resolution model has achieved its training objective, and to adjust the model parameters of the super-resolution model.

Based on this, in the present disclosure, for each type of encoding group, the first sample image corresponding to that encoding type group can be used as training data, and the second sample image corresponding to the first sample image can be used as the training target. A super-resolution model corresponding to that encoding type can then be trained using a loss function.

The loss function can be selected based on actual needs, which is not limited in the present disclosure.

In some embodiments, in the loss function used for training the super-resolution model, different regional weights may be assigned to different regions of the second sample image. In some cases, the second sample image may exhibit varying levels of detail complexity in different regions.

In some embodiments, in the second sample image, each region may have a one-to-one correspondence with the corresponding region in the target image generated by the super-resolution model based on the first sample image. Based on this, the value of the loss function may be related to the differences between the target image and the second sample image in different regions, as well as the corresponding regional weights for those different regions.

Unlike conventional loss functions, whose values depend only on the overall difference between the target image generated by the super-resolution model and the second sample image, in the present disclosure, since different regions of the second sample image may be assigned with different regional weights in the loss function, the super-resolution model's ability to learn details in regions that meet the required complexity is enhanced during the training process.

The second sample image may be divided into different regions based on various criteria. The following describes several possible ways to divide the second sample image into different regions.

In some embodiments, in the second sample image, detailed regions and flat regions may be distinguished. Based on this, in the loss function, different regional weights may be assigned to the detailed and flat regions of the second sample image, with the regional weight of the detailed regions being greater than the regional weight of the flat regions. In this way, during the training of the super-resolution model, it is possible to enable the model to learn more detailed information from the second sample image, thereby enhancing the sharpness of the detailed regions in the generated image. At the same time, the smoothness of flat regions in the generated image can be maintained, thereby reducing the introduction of new noise into the image due to sharpening processing.

The detailed regions of an image refer to areas where pixel values change dramatically and contain rich information. Detailed regions of an image generally contain edges, textures, patterns, or complex structures. The flat regions in an image refer to areas where the pixel values change gradually and contain relatively little information. For example, areas in an image where the level of detail complexity is not lower than a set threshold can be considered as detailed regions, while areas where the level of detail complexity is lower than the set threshold can be considered as flat regions. An image can include one or more detailed regions, and correspondingly, it can also include one or more flat regions.

The present disclosure does not limit the specific implementation for determining detailed and flat regions in an image. For ease of understanding, the following describes two different implementation methods.

In some cases, edge detection algorithms may be used to detect edge and non-edge regions in an image. Edge regions generally correspond to detailed regions, while non-edge regions generally correspond to flat regions. The specific implementation process can include: performing edge detection on the image to obtain a binarized edge map; determining regions containing white pixels in the edge map as detail regions, and determining regions containing black pixels as flat regions.

In other cases, textual analysis methods may be used to determine the detailed and flat regions of an image based on its texture complexity. Texture complexity reflects the richness of texture in a local region of an image. Regions with texture complexity not lower than a set complexity threshold can be considered as detail regions, while regions with texture complexity below this threshold can be considered as flat regions. For example, texture feature extraction methods such as local binary patterns and gray-level co-occurrence matrices can be used to extract texture feature values from different pixel regions in an image. These texture feature values can characterize texture complexity, and accordingly, the detailed and flat regions of the image can be determined by combining them with a set texture feature threshold.

Of course, other methods can be used to determine the detailed and flat regions in an image, which will not be described in detail here.

In some embodiments, based on the objects present in the second sample image, the second sample image may be divided into object regions containing objects and background regions without objects, resulting in multiple distinct regions within the second sample image.

The object and background regions in the second sample image may be determined using edge detection algorithms or object recognition models, which is not limited in the present disclosure. Take the determination of object and background regions in the second sample image using an edge detection algorithm as an example. Based on edge detection algorithms, the edges of each object in the second sample image can be detected, thereby obtaining the object regions and the background regions outside the object regions in the second sample image.

In some embodiments, target of interest may be defined in the second sample image to determine the regions of interest and non-interest in the second image, resulting in multiple different regions within the second sample image. For example, an identification model may be used to identify regions of interest and non-interest in the second sample image. Alternatively, a semantic segmentation algorithm may be used to perform semantic segmentation on the second sample image to segment the regions of interest and non-interest within the second sample image. Of course, other methods can be used to determine the regions of interest and non-interest in the second sample image, which is not limited in the present disclosure.

There are many forms of the loss function. For example, the loss function may be a pixel-level loss function. In the pixel-level loss function, at least one of: the absolute difference between the pixel values of the target image and the second sample image at different pixel locations, and the squared difference between them, can be calculated. In another example, the loss function may be a perceptual loss function, in which the distance between the target image and the second sample image in the feature space is calculated. In another example, the loss function may be a gradient loss function. Of course, the loss function can take other forms, which is not limited in the present disclosure.

To better describe how different regional weights are assigned to different regions of the second sample image within the loss function, the following takes the pixel-level loss function as the loss function and a specific functional form of the loss function as an example. The following formula is an expression of the loss function:

$$LOSS = \frac{1}{N} {\sum }_{i = 1}^{H} {\sum }_{j = 1}^{W} {W}_{ij} \cdot {( {I}_{p , ij} - {I}_{g , ij} )}^{2}$$

where N is the total number of pixels in the second sample image (or the target image); H and W represent the height and width of the second sample image, respectively, which are the number of pixels in each column and the number of pixels in each row of the second sample image. Wᵢⱼ represents the weight corresponding to the pixel located at the specified row and column in the second sample image, I_{p,ij} represents the pixel value of the pixel at the i^{th} row and j^{th} column in the target image generated by the super-resolution model, and I_{g,ij} represents the pixel value of the pixel at the j^{th} row and i^{th} column in the second sample image.

In the present disclosure, different regions of the second sample image or target image may have different regional weights; therefore, in the above formula, the weight Wᵢⱼ of a pixel is the weight of the region in the second sample image (or target image) that corresponds to that pixel's location. Therefore, the weight Wᵢⱼ corresponding to the pixels located in different regions of the second sample image may also be different.

In some embodiments, in order to reduce the noise that may be amplified by the super-resolution model during the reconstruction of super-resolution images, a noise suppression term may be included in the loss function. In the noise suppression term, different suppression weights may be assigned to different pixel regions in the second sample image, and each pixel region may include at least one pixel.

For any pixel region in the second sample image, the greater the difference between that pixel region and the corresponding pixel region in the target image, the greater the suppression weight assigned to that pixel region. In some embodiments, the target image may be an image generated by the super-resolution model through processing the first sample image.

In some embodiments, the corresponding pixel region in the target image may be the pixel region with the same coordinate area as the pixel region in the second sample image. Based on this, the suppression weight corresponding to the pixel region in the second sample image may be the same as the suppression weight corresponding to the corresponding pixel region in the target image.

In some embodiments, the value of the noise suppression term may be determined by the weighted sum of the differences between the target image and the second sample image in each pixel region, based on the suppression weights assigned to each pixel region in the second sample image. In this way, the larger the value of the noise suppression term, the larger the value of the loss function.

It should be understood that the greater the difference between the target image and the second sample image in the same pixel region, the more noise there is in that pixel region of the target image. In order to reduce noise within the pixel regions of the target image during super-resolution model training, in the present disclosure, a larger weight (i.e., suppression weight) may be assigned to pixel regions where the difference between the target image and the second sample image is significant. This allows the super-resolution model to focus its learning on pixel regions where the target image and the second sample image have significant differences, thereby reducing noise in those regions of the target image.

As the super-resolution model is trained, the difference between the target image and the second sample image may change across different pixel regions. Therefore, as the difference between the target image and the second sample image changes across different pixel regions, the corresponding suppression weights for those pixel regions may also be adaptively adjusted.

Continue with the formula above as an example. As the super-resolution model is continuously trained, the differences between the target image and the second sample image will vary across different pixel regions. This leads to changes in the suppression weights corresponding to these pixel regions, and consequently, the weights of individual pixels Wᵢⱼ within those regions will also change.

It should be understood that, in practical applications, the loss function for training super-resolution models can incorporate both scenarios described above. That is, while assigning different regional weights to different regions of the second sample image in the loss function, the loss function may also include the loss suppression term described above. For example, in the loss function, the weight assigned to a particular pixel in the second sample image includes both weight a and weight b. Weight a is a fixed weight assigned to the region containing the pixel in the second sample image, and weight b is a suppression weight determined based on the difference between that pixel in the second sample image and the corresponding pixel in the target image. Therefore, as the super-resolution model is continuously trained, weight b can be a variable weight.

In some embodiments, the first sample image can be a static image including static objects such as landscapes or objects, or a dynamic image including dynamic objects such as animals or people, or a dynamic image derived from a video. To more effectively train the super-resolution model for each encoding type group, different loss functions may be determined based on the proportion of static and dynamic images in the first sample image corresponding to that encoding type group.

In some embodiments, the loss function used to train the super-resolution model for each type of encoding group may be matched to the encoding characteristics of the corresponding encoding method. Based on this, for any given group of encoding types, if the encoding methods within that group have different encoding characteristics, the loss function chosen for training the corresponding super-resolution model may also be different. Specifically, the appropriate loss function can be determined by considering the common edge features shared by the various encoding methods within that encoding type group. It should be understood that, the loss function for training a super-resolution model can include one or more of the possible scenarios described above, which is not limited in the present disclosure.

There are several possible methods to obtain the second sample image.

In some embodiments, the second sample image may be the original image corresponding to the first sample image described above, that is, the unencoded original image corresponding to the first sample image.

In this case, for each type of encoding group, the unencoded original image can be first obtained. Then, the encoder corresponding to the encoding method of that encoding group can be used to encode the original image, resulting in the first sample image. Subsequently, the original image corresponding to the first sample image can be determined as the second sample image.

By compressing and encoding the original image, not only is the resolution of the original image reduced, but compression noise is also introduced, resulting in the generated first sample image being of lower quality than its corresponding original image. In the present disclosure, the first sample image is used as training data to train a super-resolution model. The purpose is to train the super-resolution model such that it can restore the first sample image to its original image.

In some embodiments, the second sample image may be an optimized image obtained by applying image optimization processing to the original image corresponding to the first sample image.

Optimizing the original image can improve its image quality. Therefore, the quality of the optimized image can be higher than the quality of both the first sample image and the second sample image. Based on this, training the super-resolution model using an optimized image as the second sample image corresponding to the first sample image is more beneficial to improving the quality of the images generated by the super-resolution model.

The method of optimizing the original image can be any processing method that improves the quality of the original image, which is not limited in the present disclosure.

In some embodiments, considering that the detailed regions in an image include richer information, in the present disclosure, an optimized image may be obtained by sharpening the detailed regions of the original image. During the process of sharpening the detailed regions of the original image, the flat regions of the original image can remain unchanged.

Based on this, since the optimized image is obtained simply by sharpening the detailed regions of the original image, using the optimized image as the second sample image corresponding to the first sample image to train the super-resolution model can enhance the model's ability to learn detailed information in the image. This not only improves the image quality generated by super-resolution models, but also, to some extent, avoids over-processing of flat regions in the image, thereby reducing the introduction of new noise caused by the super-resolution model sharpening and enhancing flat regions during image generation.

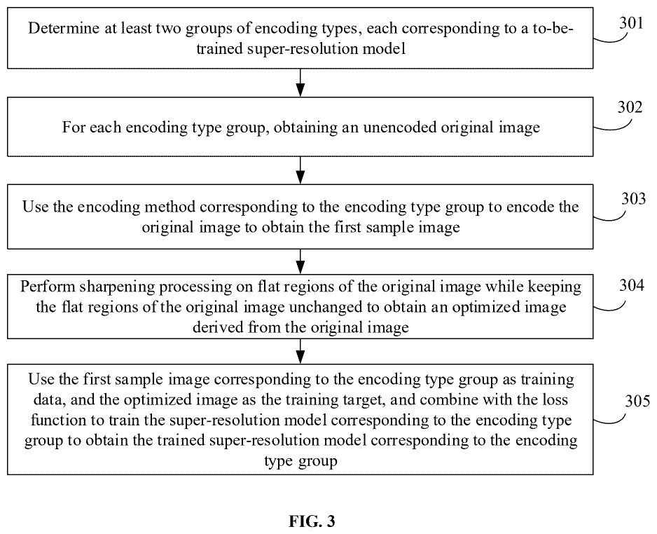

For ease of understanding, the model training method of the present disclosure will be explained below using the second sample image as an optimized image corresponding to the first sample image as an example. FIG. 3 is a flowchart of the model training method according to some embodiments of the present disclosure. The method will be described in detail below.
301, determining at least two groups of encoding types, each corresponding to a to-be-trained super-resolution model.
202, for each encoding type group, obtaining an unencoded original image.

The original image is a high-quality image that has not been encoded, such as an original image that has not been encoded using any of the encoding methods in this group of encoding types.

For each type of encoding group, at least one original image may be obtained.
303, using the encoding method corresponding to the encoding type group to encode the original image to obtain the first sample image.

For example, the original image may be encoded using the encoder corresponding to each encoding method in the group of encoding types, resulting in at least one first sample image for each encoding method in the group of encoding types, where the original image corresponding to each first sample image is the same.

It should be understood that, since each encoding method's encoder reduces the resolution of the original image and introduces noise specific to that encoder, the quality of the first sample image obtained after encoding the original image using any of these methods is lower than the quality of the original image.
304, performing sharpening processing on the flat regions of the original image while keeping the flat regions of the original image unchanged to obtain an optimized image derived from the original image.

Sharpening the flat regions of the original image can enhance the edges and details within the image, thereby improving image quality. In addition, by sharpening only the flat regions in the original image, minimal new noise is introduced, resulting in an optimized image with higher image quality than the original image.
305, using the first sample image corresponding to the encoding type group as training data, and the optimized image as the training target, and combining with the loss function to train the super-resolution model corresponding to the encoding type group to obtain the trained super-resolution model corresponding to the encoding type group.

Since the optimized image has higher image quality than the original image, using the optimized image as the training target for the super-resolution model allows for further improvement in the quality of the images generated by the super-resolution model through continuous training.

The loss function can be any one of the several possible scenarios described above, or a combination thereof, which is not limited in the present disclosure.

In some embodiments, it is also possible to train separate super-resolution models for some commonly used encoding methods, thereby obtaining at least one super-resolution model corresponding to each encoding method. Based on this, after determining the target encoding method corresponding to the first image, in the present disclosure, a query can be performed to determine whether there is a super-resolution model that corresponds exclusively to that target encoding method from the super-resolution models corresponding to at least one encoding method. If there is a super-resolution model that corresponds exclusively to the target encoding method, that super-resolution model can be determined as the target super-resolution model.

If there is no super-resolution model that corresponds exclusively to the target encoding method, the target super-resolution model corresponding to the target encoding method can be determined based on the mapping list.

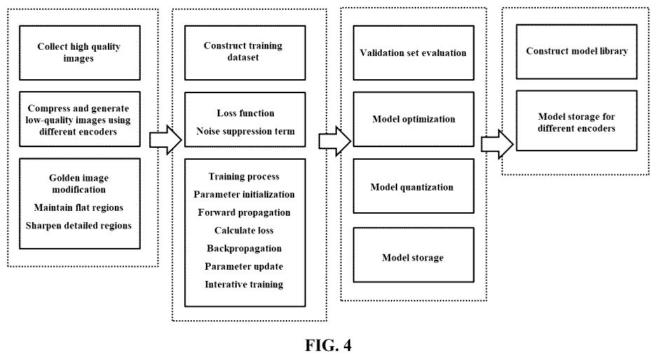

The specific implementation of training a super-resolution model corresponding to a single encoding method is similar to the process of training a super-resolution model corresponding to a group of encoding types described above. However, when training a super-resolution model corresponding to a single encoding method, the first sample images used to train that super-resolution model only include sample images that have been encoded using that specific encoding method (or encoded by the encoder corresponding to that encoding method). The following provides a brief explanation of the process of training a super-resolution model corresponding to a single encoding method in conjunction with FIG. 4. FIG. 4 is an example implementation framework for training a super-resolution model corresponding to a single encoding according to some embodiments of the present disclosure.

As shown in FIG. 4, after receiving at least one high-quality original image, for each encoding method required to train the super-resolution model, the encoder corresponding to that encoding method can be used to compress and encode each original image, generating at least one low-quality image corresponding to that encoding method. A portion of the at least one low-quality image is used as training data, forming the training dataset. The remaining low-quality images from the at least one low-quality image are used as validation data to construct the validation dataset.

In addition, before training the super-resolution model using the encoding method, the key areas of the original image (such as the detailed regions) can be optimized (e.g., sharpened), while other areas (such as the flat regions) remain unchanged, resulting in an optimized image (i.e., the golden image in FIG. 4).

Based on this, for each encoding method, low-quality images from the training dataset can be used to train the super-resolution model for the specific encoding method. A noise suppression term can be added to the loss function used in training super-resolution models. In addition, in this loss function, different regional weights can be assigned to key areas of the image (such as the detailed regions) and non-key areas (such as the flat regions), respectively. This increases the super-resolution model's learning ability and denoising capability for key areas such as the detailed regions.

Before training the super-resolution model using the values of the loss function, the model parameters of the super-resolution model may also be initialized.

During the training process, low-quality images can be input as training data into the super-resolution model being trained, causing the super-resolution model to output the target image (i.e., the forward propagation process). Based on this, the value of the loss function can be calculated using the target image and the optimized image. Based on the value of the loss function, the model parameters of the super-resolution model can be updated through backpropagation. This process can be repeated multiple times to achieve iterative training of the super-resolution model.

After training the super-resolution model specifically for this encoding method, the model can be validated and optimized using low-resolution images from the validation set. Based on this, the final trained super-resolution model can be quantized, and the quantized super-resolution model can be stored in the model library. This ensures that the model library includes at least one super-resolution model suitable for an encoder of a specific encoding method.

In some embodiments, after determining the target encoding method corresponding to the first image, if the target encoding method is found in the mapping list, the target super-resolution model corresponding to that target encoding method can be directly determined from the mapping list.

However, due to the large number of encoding methods, and the limited number of encoding methods that can be recorded in the mapping list, it is possible that the target encoding method corresponding to the first image may not be found in the mapping list after it has been determined. In this case, it is also possible to determine, from the mapping list, the group of target encoding types whose similarity to the target encoding method meets the requirements. Correspondingly, the target resolution model corresponding to the target encoding type group can be determined from the mapping list, and the first image can then be processed using the target super-resolution model corresponding to the target encoding type group.

For example, the group of encoding types with the highest similarity to the target encoding method can be determined as the target encoding type group; alternatively, the group of encoding types whose similarity to the target encoding method exceeds a set threshold can be determined as the target encoding type group.

There are various ways to determine the similarity between the encoding method corresponding to a given encoding type group and the target encoding method.

For example, for each group of encoding types in the mapping list, the similarity between the target encoding method and each encoding method within that group can be calculated. Correspondingly, the encoding type group including the encoding methods that meet the similarity requirements with the target encoding method can be determined as the target encoding type group.

Calculating the similarity between the target encoding method and the encoding methods in the encoding type group can be performed by calculating the vector similarity between the vector corresponding to the target encoding method and the vectors corresponding to the encoding methods in that encoding type group. The vector corresponding to the target encoding method can be a vector derived from the name of the target encoding method, or it can be obtained by extracting the encoding characteristics of the target encoding method. These encoding features may include encoding principles or applicable scenarios, among other characteristics. Based on the target encoding method, the encoding characteristics can be used to determine the vector corresponding to the target encoding method. The process for determining the vectors corresponding to the encoding methods within the encoding type group is similar and will not be described in detail here.

In some embodiments, for each group of encoding types in the mapping list, the similarity between the target encoding method and each encoding method within that group may be calculated. Based on this, for each group of encoding types, the average or weighted average of the similarity values for each encoding method within the encoding type group can be determined. The average or weighted average of the corresponding similarity values can be determined as the similarity between the encoding method of the encoding type group and the target encoding method. This allows for the identification of the target encoding type group whose encoding method has a similarity to the target encoding method that meets the requirements. For example, the group of encoding types with the highest average similarity score can be determined as the target encoding type group.

It should be understood that there may be multiple groups of encoding types whose corresponding encoding methods have a similarity to the target encoding method that meets the requirements. In this case, one encoding type group can be randomly selected from the identified multiple encoding type groups to serve as the target encoding type group.

In some embodiments, if multiple groups of encoding types have a similarity to the target encoding method that meets the requirements, then all of these groups of encoding types can be designated as the target encoding type group. Based on this, multiple target super-resolution models corresponding to different target encoding type groups can be combined to process the first image.

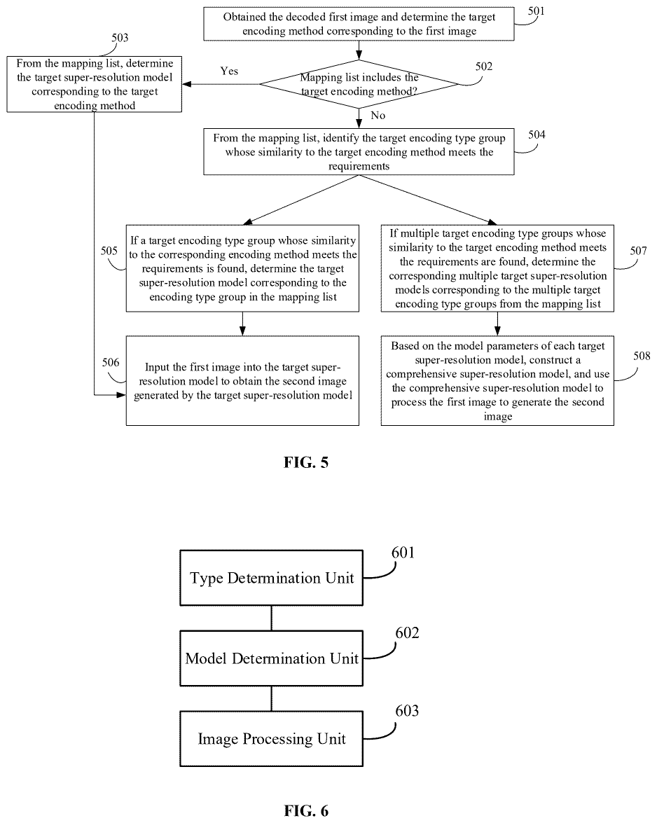

FIG. 5 is a flowchart of the image processing method according to some embodiments of the present disclosure. The method will be described in detail below.
501, obtaining a first decoded image and determining the target encoding method corresponding to the first image.
502, querying if the target encoding method is in the mapping list; if so, proceed to the process at 503; otherwise, proceed to the process at 504.

The mapping list may record various encoding type groups, each including at least two encoding methods, as well as the corresponding super-resolution model for each encoding type group.
503, determining the target super-resolution model corresponding to the target encoding method from the mapping list, then proceed to the process at 506.
504, identifying the group of target encoding types whose similarity to the target encoding method meets the requirements from the mapping list.

In some embodiments, if the target encoding method is not in the mapping list, based on the encoding methods included in each encoding type group, the target encoding type group may be determined by identifying the group whose encoding methods have a similarity to the target encoding method that meets the requirements. That is, determining the group of target encoding types that the encoding characteristics of the target encoding method may match.

For example, the group of target encoding types that has the highest similarity to the included encoding method and the target encoding method may be determined from the mapping list as the target encoding type group.
505, if a target encoding type group is identified whose similarity between the corresponding encoding method and the target encoding method meets the requirements, identifying the target super-resolution model in the mapping list that corresponds to the target encoding type group, and proceeding to the process at 506.
506, inputting the first image into the target super-resolution model and obtaining the second image generated by the target super-resolution model.

If the target encoding method is not found in the mapping list, proceed to determine if there is a target encoding type group in the mapping list whose similarity to the target encoding method meets the requirements. If a target encoding type group is found during the query, the first image can be processed directly using the target super-resolution model corresponding to the target encoding type group. This allows for the selection of a suitable super-resolution model from the mapping list even when a new encoding method not present in the list is encountered, without requiring retraining of the corresponding super-resolution model.

Specifically, when there is only one target encoding type group whose similarity to the corresponding encoding method meets the requirements, it may indicate that the encoding characteristics of the target encoding method are similar to the encoding characteristics of each encoding method within that target encoding type group. Therefore, the target encoding method may also be added to the list of encoding methods included in the target encoding type group in the mapping list.
507, if multiple target encoding type groups are identified whose similarity to the target encoding method meets the requirements, determining the multiple target super-resolution models from the mapping list for these multiple target encoding type groups.
508, based on the model parameters of each target super-resolution model, constructing a comprehensive super-resolution model, and using the comprehensive super-resolution model to process the first image to generate the second image.

In some embodiments, based on the model parameters of various target super-resolution models, constructing a comprehensive super-resolution model may involve fusing the weights and other model parameters of multiple target super-resolution models to create a new super-resolution model.

For ease of distinction, in the present disclosure, the super-resolution model constructed based on each target super-resolution model is referred to as a comprehensive super-resolution model.

The comprehensive super-resolution model combines the image processing characteristics of various target super-resolution models and is applicable to a wider range of encoding methods. Therefore, using the comprehensive super-resolution model to process the first image can also generate a high-quality second image, and there is no need to retrain a new super-resolution model.

It should be understood that the process at 508 is illustrated using an example implementation where multiple target super-resolution models, corresponding to multiple target encoding type groups, are applied to the first image. In practical applications, after determining the multiple target super-resolution models corresponding to the multiple target encoding type groups, each target super-resolution model may be used to process the first image separately to obtain candidate images generated by each target super-resolution model. Based on the weights corresponding to each target super-resolution model, the candidate images obtained by processing the first image with each target super-resolution model can be fused to obtain the second image.

The weights corresponding to each target super-resolution model can be preset. Alternatively, the weights of the target super-resolution models corresponding to each target encoding type group can be determined based on the similarity between the encoding method of each target encoding type group and the encoding method of that target, which is not limited in the present disclosure.

Corresponding to the image processing method provided in the present disclosure, an embodiment of the present disclosure also provides an image processing apparatus.

FIG. 6 is a schematic structural diagram of an image processing apparatus according to some embodiments of the present disclosure. As shown in FIG. 6, the image processing apparatus includes a type determination unit 601, a model determination unit 602 and an image processing unit 603.

In some embodiments, the type determination unit 601 may be configured to obtain the decoded first image and determine the target encoding method corresponding to the first image.

In some embodiments, the model determination unit 602 may be configured to determine the target super-resolution model corresponding to the target encoding method from a plurality of super-resolution models. The plurality of super-resolution models may correspond to different groups of encoding types. The target encoding method may match the group of encoding types corresponding to the target super-resolution model, and the encoding methods within the same group of encoding types may share at least one common encoding characteristic.

In some embodiments, the image processing unit 603 may be configured to process the first image using the target super-resolution model to generate the second image.

In some embodiments, the model determination unit may include a model determination subunit. The model determination subunit may be configured to determine the target super-resolution model corresponding to the target encoding method based on a mapping list. The mapping list may record various encoding type groups, each including at least two encoding methods, and the super-resolution model corresponding to each encoding type group.

In some embodiments, the model determination subunit may include a first determination subunit and a second determination subunit. The first determination subunit may be configured to determine the target super-resolution model corresponding to the target encoding method from the mapping list if the target encoding method is found in the mapping list. The second determination subunit may be configured to determine the target encoding type group whose similarity to the target encoding method meets the requirements from the mapping list if the target encoding method is not found in the mapping list, and determine the target super-resolution model corresponding to the target encoding type group in the mapping list.

In some embodiments, when determining the target super-resolution model corresponding to the target encoding type group in the mapping the second determination subunit may be configured to determine the plurality of target super-resolution models corresponding to the plurality of target encoding type groups in the mapping list if the plurality of target encoding type groups are identified from the mapping list.

In some embodiments, the image processing unit may include a first processing subunit or a second processing subunit. The first processing subunit may be configured to process the first image using each target super-resolution model separately. Based on the weights corresponding to each target super-resolution model, the candidate images obtained by processing the first image with each target super-resolution model can be fused to obtain the second image. The second processing subunit may be configured to construct a comprehensive super-resolution model based on the model parameters of each target super-resolution model, and to process the first image using the comprehensive super-resolution model to generate a second image.

In some embodiments, the super-resolution model recorded in the mapping list used in the model determination subunit may be trained using the first sample image encoded with each encoding method in the set of encoding types as training data and the second sample image corresponding to the first sample image as the training target to train a super-resolution model corresponding to the encoding type group, where the quality of the second sample image may be higher than the quality of the first sample image.

In some embodiments, the second sample image corresponding to the first sample image may be either: the unencoded original image corresponding to the first sample image, or an optimized image obtained by applying image optimization processing to the original image. The quality of the original image corresponding to the first sample image may be higher than the quality of the first sample image itself.

In some embodiments, when the second sample image is an optimized image, the optimized image may be obtained by sharpening the detailed regions of the original image.

In some embodiments, in the loss function used to train the super-resolution model, different regions of the second sample image may be assigned with different regional weights, different regions of the second sample image exhibiting varying levels of detail complexity.

In some embodiments, the loss function used to train the super-resolution model may include a noise suppression term. The noise suppression term, different suppression weights may be assigned to different pixel regions in the second sample image. The greater the difference between the pixel region in the second sample image and the corresponding pixel region in the target image, the greater the suppression weight assigned to the pixel region in the second sample image. The pixel region may include at least one pixel, and the target image may be the image generated by the super-resolution model through processing the first sample image.

In some embodiments, the loss function used to train the super-resolution model for each group of encoding types may be matched to the encoding characteristics of the corresponding encoding method for that group.

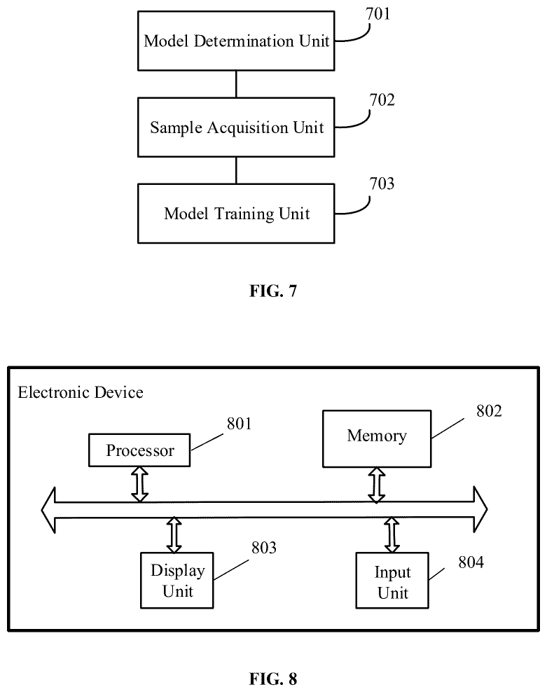

Corresponding to the model training method in the present disclosure, an embodiment of the present disclosure also provides a model training apparatus. FIG. 7 is a schematic structural diagram of a model training apparatus according to some embodiments of the present disclosure. As shown in FIG. 7, the model training apparatus includes a model determination unit 701, a sample acquisition unit 702 and a model training unit 703.

In some embodiments, the model determination unit 701 may be configured to determine the to-be-trained super-resolution models, each corresponding to at least two groups of encoding types, where the encoding methods matched to the same group of encoding types share at least one common encoding characteristic.

In some embodiments, the sample acquisition unit 702 may be configured to obtain, for each encoding method corresponding to each encoding type group, a first sample image encoded using the encoding method corresponding to that encoding type group, and a second sample image corresponding to the first sample image, the quality of the second sample image being higher than the quality of the first sample image.

In some embodiments, the model training unit 703 may be configured to train a super-resolution model for each group of encoding types using the first sample image corresponding to that group of encoding types as the training data and the second sample image corresponding to the first sample image as the training target to obtain a trained super-resolution model corresponding to the group of encoding types.

In some embodiments, the sample acquisition unit may include an original image acquisition subunit, an encoding processing subunit and an image determination subunit.

In some embodiments, the original image acquisition subunit may be configured to obtain the unencoded original image.

In some embodiments, the encoding processing subunit may be configured to encode the original image using the encoding method corresponding to the encoding type group to obtain a first sample image.

In some embodiments, the image determination subunit may be configured to determine the second sample image corresponding to the first sample image using either the original image or an optimized image obtained by processing the original image.

In some embodiments, the model training unit may be configured to train the super-resolution model corresponding to the encoding type group using the first sample image corresponding to the encoding type group as training data, the second sample image corresponding to the first sample image as the training target, and the loss function.

In some embodiments, in the loss function, different regional weights may be assigned to different regions in the second sample image, different regions in the second sample image exhibiting varying levels of detail complexity.

In some embodiments, the loss function may include a noise suppression term. In the noise suppression term, different suppression weights may be assigned to different pixel regions in the second sample image. The greater the difference between the pixel region in the second sample image and the corresponding pixel region in the target image, the greater the suppression weight assigned to the pixel region in the second sample image. The target image may be an image generated by the super-resolution model by processing the first sample image, and the pixel region may include at least one pixel.

In some embodiments, the loss function used to train the super-resolution model for each group of encoding types may be matched to the encoding characteristics of the corresponding encoding method for that group.

An embodiment of the present disclosure also provides an electronic device. FIG. 8 is a schematic structural diagram of an electronic device according to some embodiments of the present disclosure.

As shown in FIG. 8, the electronic device includes a processor 801 and a memory 802.

In some embodiments, the processor 801 can be used to execute the image processing method or model training method described in any of the foregoing embodiments.

In some embodiments, the memory 802 can be used to store the program required for the processor to perform its operations.

It should be understood that the electronic device may further include a display unit 803 and an input unit 804.

Of course, the electronic device may also include more or fewer components than those shown in FIG. 8. The components in the electronic device are not limited in the present disclosure.

An embodiment of this application further provides a computer program product. The computer program product includes computer-readable instructions. When executed by an electronic device, the computer-readable instructions can cause the electronic device to perform any of the image processing methods or model training methods described in the foregoing embodiments.

An embodiment of this application further provides a computer-readable storage medium. The computer-readable storage medium carries one or more computer programs. When executed by an electronic device, the one or more computer programs can cause the electronic device to perform any of the image processing methods or model training methods described in the foregoing embodiments.

In addition, it should be noted that the described apparatus embodiment is merely an example. The units described as separate parts may or may not be physically separate, and parts displayed as units may or may not be physical units, may be located in one position, or may be distributed on a plurality of network units. Some or all the modules may be selected based on an actual requirement to achieve the objectives of the solutions of the embodiments. In addition, in the accompanying drawings of the apparatus embodiments provided in this application, connection relationships between modules indicate that the modules have communication connections with each other, which may be specifically implemented as one or more communication buses or signal cables.

Based on the description of the foregoing implementations, a person skilled in the art may clearly understand that this application may be implemented by software in addition to necessary universal hardware, or by dedicated hardware, including a dedicated integrated circuit, a dedicated CPU, a dedicated memory, a dedicated component, and the like. Generally, any functions that can be performed by a computer program can be easily implemented by using corresponding hardware. Moreover, a specific hardware structure used to achieve a same function may be in various forms, for example, in a form of an analog circuit, a digital circuit, or a dedicated circuit. However, as for this application, software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (e.g., a personal computer, a training equipment, a network equipment, etc.) to perform the methods described in embodiments of the present disclosure.

All or some of the foregoing embodiments may be implemented by using software, hardware, firmware, or any combination thereof. When software is used to implement the embodiments, all or a part of the embodiments may be implemented in a form of a computer program product.

The computer program product includes one or more computer instructions. When the computer program instructions are loaded and executed on the computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, communication apparatus, computing device, or data center to another website, computer, communication apparatus, computing device, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a communication apparatus or a data center, integrating one or more usable media. The usable medium may be a magnetic medium (for example, a floppy disk, a hard disk, or a magnetic tape), an optical medium (for example, a DVD), a semiconductor medium (for example, a solid-state disk (SSD)), or the like.

What is claimed is:

1. An image processing method comprising:
obtaining a first decoded image and determining a target encoding method corresponding to the first image;
from a plurality of super-resolution models, determining a target super-resolution model corresponding to the target encoding method, the plurality of super-resolution models corresponding to different encoding type groups, the target encoding method matching the encoding type group corresponding to the target super-resolution model, encoding methods within the same encoding type group sharing at least one common encoding characteristic; and
using the target super-resolution model to process the first image to obtain a second image.

2. The image processing method of claim 1, wherein determining the target super-resolution model corresponding to the target encoding method from the plurality of super-resolution models include:
determining the target super-resolution model corresponding to the target encoding method based on a mapping list, the mapping list being configured to record a plurality of encoding type groups, each including at least two encoding methods and the super-resolution model corresponding to each encoding type group.

3. The image processing method of claim 2, wherein determining the target super-resolution model corresponding to the target encoding method based on the mapping list includes:
if the target encoding method is found in the mapping list, determining the target super-resolution model corresponding to the target encoding method from the mapping list; and
if the target encoding method is not found in the mapping list, determining the target encoding type group whose corresponding encoding method has a similarity to the target encoding method that meets requirements from the mapping list, and determining the target super-resolution model corresponding to the target encoding type group in the mapping list.

4. The image processing method of claim 3, wherein determining the target super-resolution model corresponding to the target encoding type group in the mapping list includes:
if a plurality of target encoding type groups are identified from the mapping list, determining the plurality of target super-resolution models corresponding to the plurality of target encoding type groups in the mapping list, and
using the target super-resolution models to process the first image to generate the second image includes:
using each of the target super-resolution models to process the first image, and based on weights corresponding to each target super-resolution model, fusing candidate images obtained by processing the first image with each target super-resolution model to obtain the second image; or,
based on model parameters of each target super-resolution model, constructing a comprehensive super-resolution model, and using the comprehensive super-resolution model to process the first image to generate the second image.

5. The image processing method of claim 2, wherein:
the super-resolution model recorded in the mapping list is the super-resolution model corresponding to the encoding type group trained using a first sample image encoded with each encoding method in the encoding type group as training data and a second sample image corresponding to the first sample image as a training target, quality of the second sample image being higher than quality of the first sample image.

6. The image processing method of claim 5, wherein the second sample image corresponding to the first sample image is: an unencoded original image corresponding to the first sample image, or an optimized image obtained by image optimization processing of the original image, quality of the original image corresponding to the first sample image being higher than quality of the first sample image, the optimized image being obtained by sharpening detailed regions of the original image.

7. The image processing method of claim 5, wherein:
in a loss function used to train the super-resolution model, different regional weights are assigned to different regions of the second sample image, different regions in the second sample image having varying levels of detail complexity; and/or,
the loss function used to train the super-resolution model includes a noise suppression term, in the noise suppression term, different suppression weights are assigned to different pixel regions in the second sample image, the greater the difference between the pixel region in the second sample image and the corresponding pixel region in a target image, the greater the suppression weight assigned to that pixel region in the second sample image, the pixel region including at least one pixel, the target image being an image generated by the super-resolution model through processing the first sample image; and/or,
the loss function used to train the super-resolution model corresponding to each encoding type group is matched to encoding characteristics of the encoding method corresponding to the encoding type group.

8. A model training method comprising:
determining at least two encoding type groups, each corresponding to a to-be-trained super-resolution model, encoding methods within the same encoding type group sharing at least one common encoding characteristic;
for each encoding method corresponding to each encoding type group, obtaining a first sample image encoded using the encoding method corresponding to the encoding type group, and a second sample image corresponding to the first sample image, quality of the second sample image being higher than quality of the first sample image; and
for each encoding type group, using the first sample image corresponding to the encoding type group as training data and the second sample image corresponding to the first sample image as a training target to train the super-resolution model corresponding to the encoding type group to obtain a trained super-resolution model corresponding to the encoding type group.

9. The model training method of claim 8, wherein obtaining the first sample image encoded using the encoding method corresponding to the encoding type group and the second sample image corresponding to the first sample image includes:
obtaining an unencoded original image;
using the encoding method corresponding to the encoding type group to obtain the first sample image; and
determining the original image or an optimized image obtained by processing the original image as the second sample image corresponding to the first sample image.

10. The model training method of claim 8, wherein using the first sample image corresponding to the encoding type group as the training data and the second sample image corresponding to the first sample image as the training target to train the super-resolution model corresponding to the encoding type group includes:
using the first sample image corresponding to the encoding type group as the training data and the second sample image corresponding to the first sample image as the training target to train the super-resolution model corresponding to the encoding type group in conjunction with a loss function, wherein:
in the loss function, different regional weights are assigned to different regions in the second sample image, different regions in the second sample image having varying levels of detail complexity; and/or,
the loss function includes a noise suppression term, in the noise suppression term, different suppression weights being assigned to different pixel regions in the second sample image, the greater the difference between the pixel region in the second sample image and the corresponding pixel region in a target image, the greater the suppression weight assigned to that pixel region in the second sample image, the target image being an image generated by the super-resolution model by processing the first sample image, the pixel region including at least one pixel; and/or,
the loss function used to train the super-resolution model for each encoding type group corresponding to the encoding characteristics of the encoding method corresponding to the encoding type group.

11. An image processing apparatus comprising:
a type determination unit, the type determination unit being configured to obtain a decoded first image and determine a target encoding method corresponding to the first image;
a model determination unit, the model determination unit being configured to determine a target super-resolution model corresponding to the target encoding method from a plurality of super-resolution models, the plurality of super-resolution models corresponding to different encoding type groups, the target encoding method matching the encoding type group corresponding to the target super-resolution model, encoding methods within the same encoding type group sharing at least one common encoding characteristic; and
an image processing unit, the image processing unit being configured to process the first image using the target super-resolution model to generate a second image.

12. The image processing apparatus of claim 11, wherein:
the second sample image corresponding to the first sample image is: an unencoded original image corresponding to the first sample image, or an optimized image obtained by image optimization processing of the original image, quality of the original image corresponding to the first sample image being higher than quality of the first sample image, the optimized image being obtained by sharpening detailed regions of the original image.

13. The image processing apparatus of claim 11, wherein:
in a loss function used to train the super-resolution model, different regional weights are assigned to different regions of the second sample image, different regions in the second sample image having varying levels of detail complexity; and/or,
the loss function used to train the super-resolution model includes a noise suppression term, in the noise suppression term, different suppression weights are assigned to different pixel regions in the second sample image, the greater the difference between the pixel region in the second sample image and the corresponding pixel region in a target image, the greater the suppression weight assigned to that pixel region in the second sample image, the pixel region including at least one pixel, the target image being an image generated by the super-resolution model through processing the first sample image; and/or,
the loss function used to train the super-resolution model corresponding to each encoding type group is matched to encoding characteristics of the encoding method corresponding to the encoding type group.
